(19) United States
(12) Patent Application Publication
(10) Pub. No.: US 2005/0261121 A1
(43) Pub. Date: Nov. 24, 2005

(54) Elimination of crystalline silica from white foam glass by chemical additions

(75) Inventors: Richard Lehman, Princeton, NJ (US); Steven C. Haines, Santa Fe, NM (US); Andrew Ungerleider, Santa Fee, NM (US)

Correspondence Address: ROBERT W. BECKER & ASSOCIATES, Suite B, 707 Highway 66 East, Tijeras, NM, 87059, US

(73) Assignee: Earthstone International LLC, Santa Fe, NM (US)

(21) Appl. No.: 10/848,844

(22) Filed: May 19, 2004

(51) Int. Cl. C03C 11/00; C03B 19/08

(52) U.S. Cl. 501/39; 65/22; 264/42

(57) ABSTRACT

A method of making a foam glass preparation is provided. The following are mixed together: powdered or ground glass, at least one non-sulfur based foaming agent, and at least one additive that reduces the crystalline silica content in the foam glass derived from the preparation to less than 1% (volume basis).

### BACKGROUND OF THE INVENTION

The present invention relates to a method of making foamed glass while significantly reducing or eliminating crystalline silica from the finished product.

Silica is the generic term for minerals with the chemical formula SiO₂. Silica collectively describes crystalline and non-crystalline forms. Crystalline silica (quartz, crystobalite, or tridymite) occurs in nature and can be artificially produced by heating silicate glasses or other amorphous silicates.

Occupational exposure to crystalline silica dust constitutes a serious health hazard. This health hazard is also a concern for consumers using products containing crystalline silica. Silica is found in a large number of consumer products. Spackling patching and taping for drywall construction are formulated from minerals including crystalline silica, and silica flour is added to toothpaste, scouring powders, wood fillers, soaps, paints and porcelain. Consumers may be exposed to respirable crystalline silica from abrasives, sand paper, detergent, cement and grouts. The primary health concerns in subjects exposed to silica dust are the fibrogenic capacity of the inhaled silica particles that can lead to the development of silicosis and the increased risk of tuberculosis. Nationally, the US Occupational Safety and Health Administration (OSHA) and the US National Institute for Occupational Safety and Health (NIOSH) set and regulate inhalation standards for silica dust. Internationally, the International Labour Organization (ILO) and the World Health Organization (WHO) have developed programs to reduce exposure of silica dust in developed and developing countries.

Workers in the foam glass manufacturing sector can be exposed to levels of crystalline silica during production. Consumers use foam glass blocks and powder for surface preparation by sanding, rubbing and/or scraping a surface to clean, abrade and polish such a surface. Fine dust containing varying percentages of crystalline silica can be created and inhaled. Workers in other industries can have exposure to crystalline silica from foamed glass. The building material and insulation industries work with foamed glass in various forms and can be exposed in the cutting and handling of products made from foamed glass.

The manufacture of foamed glass is conducive to transforming part of the amorphous ground glass (silica) into crystalline silica. The thermal profile required for production of foamed glass is often consistent with devitrification of the glass matrix. Crystalline silica, usually in the form of crystobalite, may be a devitrification product. In addition, some of the common foaming agents can accelerate the conversion rate of amorphous to crystalline silica and lower the temperature at which crystal growth occurs.

It is therefore an object of the present application to significantly reduce crystalline silica from foam glass products.

### SUMMARY OF THE INVENTION

This and other objects and advantages of the present application are realized by significantly reducing or eliminating crystalline silica from the foam glass manufacturing process and finished products thereof.

This is accomplished by the addition of one or more chemicals or compounds to a preparation that is to be used for producing foam glass to reduce silica crystallization to less than 1% by volume. The objects and advantages will appear more clearly from the following specification in conjunction with the accompanying Examples.

The foam glass can be derived from, for example, a starting mixture that comprises virgin or waste glass derived from but not limited to pre-consumer manufacturing, post-consumer waste or specifically designed virgin glass and 0.1-20.0%, preferably 0.5-5.0%, by weight of a non-sulfur based foaming agent such as, but not limited to, barium carbonate, calcium carbonate, magnesium carbonate, sodium carbonate, sugar, urea, and mixtures thereof. The glass is preferably powdered or ground, having, for example, an average particle size distribution that ranges from 1-500 microns. Additional ingredients can be added to the mixture to change the characteristics to benefit the specifically designed finished product. For more background regarding the preparation of white foamed glass, reference is made, for example, to U.S. Pat. No. 5,972,817, Haines et al.

Products made of foam glass or containing foam glass can be, for example, a disc, block or powder for preparing surfaces such as by sanding rubbing and/or scraping the same to clean abrade, polish, smooth or the like. In addition, foam glass can be made, for example, into various building materials such as, but not limited to, a substrate for composite building panels and the like.

Consumers and workers in industry can become exposed to fine dust from foam glass in product use, along with cutting and handling materials made from foam glass.

Most crystallization results from heterogeneous nucleation on the material surface. Additives can alter the glass surface chemistry. Using highly stable glass-forming additives not prone to nucleation can prevent nucleation by the mechanism of inhibited kinetics. Generally, adding more chemicals lowers crystallization rates since single component phases crystallize most rapidly. Other additives can be seeded to encourage a silicate phase with at least two cation constituents (versus a pure silica phase), not indicated on regulatory lists subject to control, which precludes the formation of crystalline silica.

A previous manufacturing process reported data indicating crystobalite levels of 10 to 11%. X-ray diffraction analysis (XRD) was used to determine the presence of crystallinity. Semi-quantitative XRD was conducted on small, finely ground samples of foam glass using an automated diffractometer. The level of detection for crystobalite was categorized as approximately 1% (volume basis).

The main approach was surface vitrification by the addition of glass formers to the glass powder prior to foaming. A number of potential additives were experimentally tried. A number of additives, which reduced crystallization, were eliminated due to the deleterious effect on the finished product. Results of increased percentages of additives were graphed with the resulting reduction of crystobalite. Theoretical zero points were extrapolated for potential additives. Additives with very shallow graph slopes were eliminated due to the potential high percentage of additions required. A number of chemicals were successful in eliminating cristobalite without affecting the finished product. For example, various additions of chemicals such as, but not limited to, potassium phosphate tribasic, potassium phosphate, sodium phosphate and zinc oxide reduced the XRD analysis to the non-detect level for crystobalite. These additives preferably comprise less than 20% by weight, and preferably less than 10%, of the preparation that is to be used to produce foam glass.

### EXAMPLES

### Example 1

To make a foam glass surface preparation product for stripping paint off wood or metal, a mixture of the following substituents was provided:
97.5% (by weight) ground soda/lime glass, −200 mesh
11% calcium carbonate, −200 mesh
1.5% zinc oxide, −200 mesh

The mixture was then appropriately heated and subsequently annealed. The addition of zinc oxide reduced the crystobalite levels from 6% to below detection limit, or BDL, in the resulting foam glass product.

### Example 2

To make a foam glass surface preparation product for heavy duty household cleaning the following substituents were provided:
94.2% (by weight) ground soda/lime glass, −325 mesh
1% calcium carbonate, −325 mesh
4.8% potassium phosphate tribasic, −400 mesh

The addition of potassium phosphate tribasic reduced the cristobalite levels from 11% to <1% (BDL).

### Example 3

To make a foam glass substrate of a composite building panel the following substituents were provided:
92.6% (by weight) ground soda/lime glass, −200 mesh
1.5% calcium carbonate, −200 mesh
0.5% magnesium carbonate, −200 mesh
5.4% sodium phosphate, −300 mesh

The addition of sodium phosphate reduced the cristobalite levels from 8% to <1% (non-detect).

The present invention is, of course, in no way restricted to the specific disclosure of the specification and examples, but also encompasses any modifications within the scope of the appended claims.

1. A method of making a foam glass preparation, comprising mixing together powdered or ground glass, at least one non-sulfur based foaming agent, and at least one additive that reduces silica crystallization in foamed glass produced from the preparation to less than 1%.

2. A method according to claim 1, wherein said additive is selected from the group consisting of potassium phosphate, potassium phosphate tribasic, sodium phosphate and zinc oxide.

3. A method according to claim 1, wherein said additive is less than 20% by weight of the preparation.

4. A method according to claim 3, wherein said additive is less than 10% by weight of the preparation.

5. A method according to claim 1, wherein said foaming agent is at least one of the group consisting of barium carbonate, calcium carbonate, magnesium carbonate, sodium carbonate, sugar, urea and mixtures thereof.

6. A method according to claim 1, wherein said foaming agent is 0.1 to 20.0% by weight of the preparation.

7. A method according to claim 1, wherein said glass is virgin or waste glass.

8. A method according to claim 1, wherein said powdered or ground glass has an average particle size distribution that ranges from 1 to 500 microns.

9. A method of making a foam glass preparation, comprising mixing together powdered or ground glass, at least one non-sulfur based foaming agent, and at least one additive, selected from the group consisting of potassium phosphate, potassium phosphate tribasic, sodium phosphate and zinc oxide, for reducing silica crystallization in foam glass produced from the preparation to less than 1%.

10. A foam glass product made by the method of claim 1.
